(19) United States
(12) Patent Application Publication
(10) Pub. No.: US 2009/0222621 A1
(43) Pub. Date: Sep. 3, 2009

(54) MANAGING THE ALLOCATION OF TASK CONTROL BLOCKS

(75) Inventors: Kevin J. Ash, Tucson, AZ (US); Robert A. Kubo, Tucson, AZ (US); Alfred E. Sanchez, Tucson, AZ (US)

Correspondence Address: QUARLES & BRADY LLP, ONE SOUTH CHURCH AVENUE, SUITE 1700, TUCSON, AZ, 85701, US

(73) Assignee: INTERNATIONAL BUSINESS MACHINES CORPORATION, Armonk, NY (US)

(21) Appl. No.: 12/039,911

(22) Filed: Feb. 29, 2008

(51) Int. Cl. G06F 12/00

(52) U.S. Cl. 711/112; 711/E12.001

(57) ABSTRACT

Systems and methods for allocating task control blocks in an information storage and retrieval system are disclosed. Task control blocks for new writes and reads are allocated by the cache code after a determination of the number of task control blocks already allocated for other tasks.

### FIELD OF THE INVENTION

This invention relates to an apparatus and method for allocating task control blocks in a data storage and retrieval system.

### BACKGROUND OF THE INVENTION

Data storage and retrieval systems are used to store information provided by one or more host computer systems, typically, host computer systems organized into local or wide area networks. Such data storage and retrieval systems are typically composed of an array of host adapter cards that interface with host computers, a processor complex, and an array of device adapters that communicate with one or more disk drives. The processor complex typically includes a processor, cache and a non-volatile storage device (NVS) and a backup power source to ensure continued operation of the processor and the cache in the event of a power failure. The processor typically runs several processes that direct the operation of the data storage and retrieval system. One of these processes, which manages communication between the processor complex and the host adapter cards, is defined by a Host Adapter Interface (“HAI”) code.

Conventional data storage and retrieval systems receive requests to write information to one or more secondary storage devices, and requests to retrieve information from those one or more secondary storage devices. Upon receipt of a write request, conventional systems store information received from a host computer in a data cache. In some cases, a copy of that information is also stored in NVS. NVS is used as temporary storage for data in the process of being written to secondary storage devices so that data will be available in the event that the host computer systems or the data storage and retrieval systems fail during the process of storing data. Upon receipt of a read request, the system recalls information from the one or more secondary storage devices and moves that information to the data cache and then to the host.

Conventional data storage and retrieval systems are continuously moving information to and from storage devices, to and from the data cache and in certain circumstances to and from the NVS. Conventionally, task control blocks (“TCBs”) are used to manage the movement of data within a data storage and retrieval system and between a host computer and the data storage and retrieval system. TCBs are passed between various processes within the data storage and retrieval system to clear space for and manage the movement of the data to be stored or retrieved.

### SUMMARY OF THE INVENTION

The invention provides systems and methods whereby the Cache code (instead of the HAI code) controls the allocation of TCBs for new Host Adapter writes and reads. The Cache code's allocation of TCBs is based on the current knowledge of the number of existing TCBs already waiting to perform writes or reads, and the current knowledge of the number of existing TCBs already waiting to perform stage/destage work with the disk drives.

In one embodiment, methods and systems according to the invention allocate Task Control Blocks in information storage and retrieval systems that communicate with one or more host computers. Such information storage and retrieval system comprise a host adapter interface, a cache code for issuing Task Control Blocks, a data cache, a non-volatile storage, a new read Task Control Block threshold, a device adapter, and one or more information storage devices. The device adapter interconnects the data cache and the one or more information storage devices.

In certain embodiments, systems according to the invention receive a new read request from the host adapter interface, call the cache code, determine the number of Task Control Blocks already issued for previous new reads, and compare the number of Task Control Blocks already issued for previous new reads with the new read Task Control Block threshold. If the number of Task Control Blocks already issued for previous new reads exceeds the new read Task Control Block threshold, systems according to the invention queue the new read request. If the number of Task Control Blocks already issued for previous new reads does not exceed the new read Task Control Block threshold, systems according to the invention issue a Task Control Block corresponding to the new read request from the cache code.

In certain embodiments, systems according to the invention further comprise a queued stage work TCB threshold and perform the steps of determining a number of Task Control Blocks queued to perform staging of data from the one or more information storage devices to the cache, and comparing the number of Task Control Blocks queued to perform staging of data from the one or more information storage devices to the cache with the queued stage work TCB threshold. If the number of Task Control Blocks queued to perform staging of data from the one or more information storage devices to the cache exceeds the queued stage work TCB threshold, systems according to the invention queue the new read request. Alternatively, if the number of Task Control Blocks queued to perform staging of data from the one or more information storage devices to the cache does not exceed the queued stage work TCB threshold, systems according to the invention issue a Task Control Block corresponding to the new read request from the cache code.

In some embodiments, information data storage and retrieval systems according to the invention comprise a current stage work TCB threshold. Such systems determine a number of Task Control Blocks currently perform staging of data from the one or more information storage devices to the cache; and compare the number of Task Control Blocks currently performing staging of data from the one or more information storage devices to the cache with the current stage work TCB threshold. If the number of Task Control Blocks currently performing staging of data from the one or more information storage devices to the cache exceeds the current stage work TCB threshold, the system queues the new read request. Alternatively, if the number of Task Control Blocks currently performing staging of data from the one or more information storage devices to the cache does not exceed the current stage work TCB threshold, the system issues a Task Control Block corresponding to the new read request from the cache code.

In one embodiment, an information storage and retrieval system according to the invention communicates with one or more host computers. Such an information storage and retrieval system includes a host adapter interface, a cache code for issuing Task Control Blocks, a data cache, a non-volatile storage, a new write TCB threshold, a device adapter, and one or more information storage devices, said device adapter interconnecting said data cache and said one or more information storage devices. The information storage and retrieval systems receives a new write request from the host adapter interface, calls the cache code; determines a number of Task Control Blocks already issued for previous new writes, and compares the number of Task Control Blocks already issued for previous new writes with the new write Task Control Block threshold. If the number of Task Control Blocks already issued for previous new writes exceeds the new write Task Control Block threshold, the system queues the new write request. Alternatively, if the number of Task Control Blocks already issued for previous new writes does not exceed the new write Task Control Block threshold, the system issues a Task Control Block corresponding to the new write request from the cache code.

In another embodiment, the system further comprises a queued destage work TCB threshold. The system determines a number of Task Control Blocks queued to perform destaging of data from the cache to the one or more information storage devices, and compares the number of Task Control Blocks queued to perform destaging of data from cache to the one or more information storage devices with the queued destage work TCB threshold. If the number of Task Control Blocks queued to perform destaging of data from the cache to the one or more information storage devices exceeds the queued destage work TCB threshold, the system queues the new write request. Alternatively, if the number of Task Control Blocks queued to perform destaging of data from the cache to the one or more information storage devices does not exceed the queued destage work TCB threshold, the system issues a Task Control Block corresponding to the new write request from the cache code.

In another embodiment, the system further comprises a current destage work TCB threshold. The system determines a number of Task Control Blocks currently performing destaging of data from the cache to the one or more information storage devices, and compares the number of Task Control Blocks currently performing destaging of data from cache to the one or more information storage devices with the current destage work TCB threshold. If the number of Task Control Blocks currently performing destaging of data from the cache to the one or more information storage devices exceeds the current destage work TCB threshold, the system queues the new write request. Alternatively, if the number of Task Control Blocks currently performing destaging of data from the cache to the one or more information storage devices does not exceed the current destage work TCB threshold, the system issues a Task Control Block corresponding to the new write request from the cache code.

Embodiments of the invention can operate on new write requests that are cache fast writes, sequential fast writes or data storage device fast writes. In the event that a new write request is for a data storage device fast write, when determining the number of Task Control Blocks already issued for previous new writes, the system can determine the number of Task Control Blocks already issued for previous new writes in cache and non-volatile storage.

Methods and systems according to the current invention have a number advantages over conventionally configured systems. For example, methods and systems according to the invention allow for the more efficient, balanced allocation of task control blocks between read and write requests and between host adapter and stage/destage tasks, which provides for increased throughput.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing the components of a data storage and retrieval system according to the present invention;

FIG. 2 is a block diagram showing several types of code that define processes in a data storage and retrieval system according to the present invention;

FIG. 3 is a flow chart summarizing certain steps in a method of allocating Task Control Blocks for a read according to the invention;

FIG. 4 is a flow chart summarizing certain steps in a method of allocating Task Control Blocks for a Cache Fast Write or a Sequential Fast Write according to the invention; and

FIG. 5 is a flow chart summarizing certain steps in a method of allocating Task Control Blocks for a Data Storage Device Fast Write according to the invention.

### DETAILED DESCRIPTION OF THE PREFERRED EMBODIMENTS

The invention disclosed herein is based on systems and methods for issuing Task Control Blocks in data storage and retrieval systems with awareness of the allocation of existing Task Control Blocks for various tasks. The invention may be implemented as a method, instructions disposed on a computer readable medium for carrying out a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (“FPGAs”), application specific integrated circuits (“ASICs”), complex programmable logic devices (“CPLDs”), programmable logic arrays (“PLAs”), microprocessors, or other similar processing devices.

This invention is described in preferred embodiments in the following description with reference to the Figures, in which like numbers represent the same or similar elements.

When a write request issues from a host computer to an information storage and retrieval system, the process defined by the Host Adapter Interface (“HAI”) code allocates a TCB from the operating system (“OS”) code. The TCB is used to maintain information about the write process from beginning to end as data to be written is passed from the host computer through the cache and/or the NVS to the secondary storage devices. In data storage and retrieval systems, once the HAI code has allocated a TCB, the TCB is passed to the cache code in order to ensure the allocation of space for the write in the cache. If the cache is full, it may queue the TCB until existing data in the cache can be destaged, or written to secondary storage devices, in order to free up space.

Different types of write processes require different levels of use for system resources. During a Cache Fast Write (CFW) and a Sequential Fast Write (SFW), for example, data is only written to the cache, and is destaged down to data storage devices such as disk drives at a later time. During a Data Storage Device Fast Write (DFW), on the other hand, data is written to both the cache and the NVS. In the event of a DFW, once cache space is allocated, the TCB is passed to the NVS code in order to allocate space in the NVS for the write. The NVS code may also queue the TCB if the NVS is full until data stored in the NVS can be destaged to make room for the write operation. Once space is allocated in the cache and NVS, the HAI code informs the Host Adapter that the write can proceed. Once data are written to the NVS and the cache, additional TCBs are generated that destage data from the cache and the NVS down to the disk drives.

As is set forth above, when TCBs are allocated during a write, the TCBs can themselves be queued in either the cache or the NVS depending on space availability. Space availability is determined by the speed and capability of the data storage and retrieval system to destage data from cache and NVS down to the disk drives. The speed and capability to destage data from cache and NVS down to the disk drives are determined ultimately by the speed of the disk drives, the size of the disk drive array and the speed of the device adapter interface.

The number of TCBs available to the processor complex for all tasks is finite. As each new request arrives from the Host Adapter cards, the HAI code requests a new TCB from the OS code. If one is available, a TCB for the write is passed to the HAI code and the write is allowed to proceed. If a TCB is not available, the HAI code must wait for an available TCB for the write to proceed. When the HAI code requests a TCB from the OS code for a new write, the HAI code is typically not aware of whether the cache and the NVS are already full of data waiting to be destaged. This can result in a situation where the majority of TCBs are consumed by new write requests, leaving few TCBs for use in other tasks, such as destaging data from NVS and cache or new read request. Similar TCB bottlenecks can occur during read operations.

The present invention provides systems and methods that efficiently allocate TCBs by allocating TCBs for new reads and writes only after taking into account the number of TCBs that have already been allocated for other tasks.

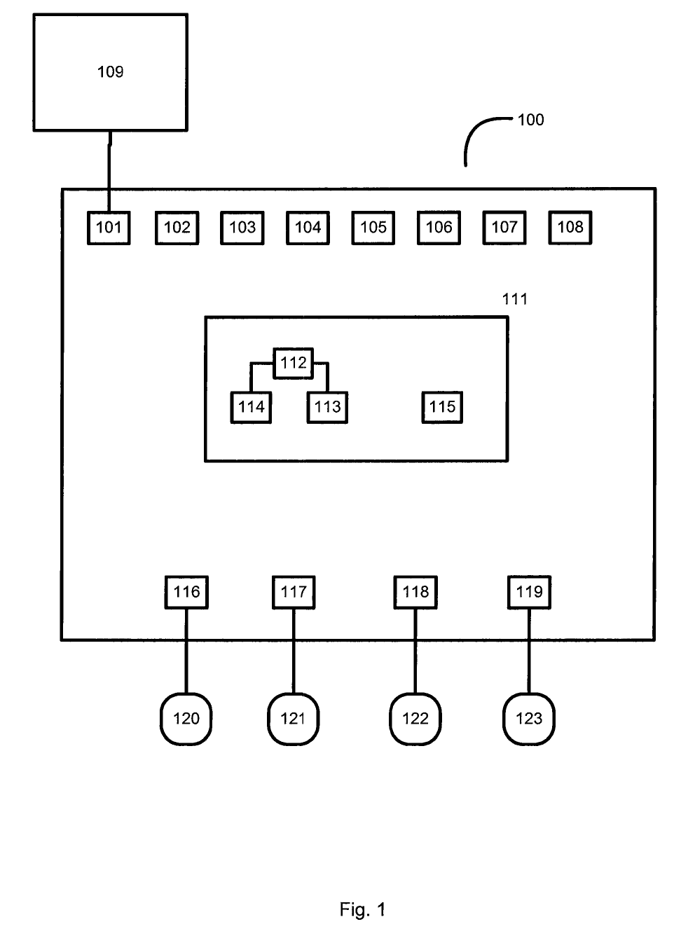

Referring now to FIG. 1, applicants' information storage and retrieval system 100 includes an array of host adapter cards 101-108 that manage communication between the information storage and retrieval system 100 and one or more host computers 109. The array of host adapter cards 101-108 includes a hardware interface of sufficient speed to allow efficient communication between the information storage and retrieval system 100 and the host computer 109. For example, the host adapter cards 101-108 can include one or more Fiber Channel ports, one or more ESCON ports, or one or more SCSI ports. Host computer 109 is optionally part of a local, wide area or global computer network.

Information storage and retrieval system 100 includes a processor complex 111. Processor complex 111 includes a power supply 112, a cache 113 and a processor 114. The power supply 112 optionally includes a battery and ensures the continued operation of the processor 114 and the cache 113 in the event of a power failure. Processor complex 111 also includes a Non-volatile storage device (“NVS”) 115. Information storage and retrieval system 100 also includes an array of device adapter cards 116-119, which manage communication between the information storage and retrieval system 100 and an array of storage devices 120-123, for example disk drives arranged in a Redundant Array of Independent Disks (“RAID”) configuration.

Information storage and retrieval systems according to the invention may optionally be arranged in clusters having redundant parallel sets of host adapter cards, processor complexes and device adapter card arrays, where each cluster can communicate between host computers and a shared array of storage devices.

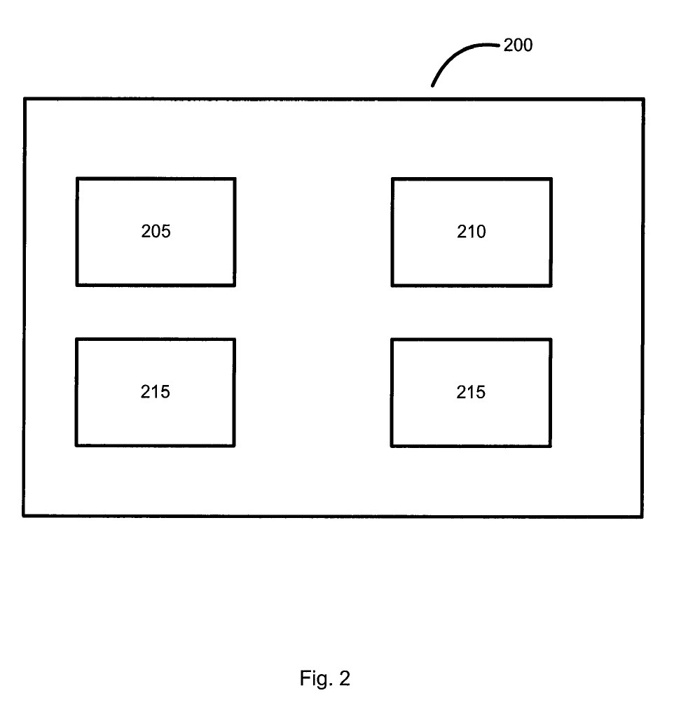

The processor 114 is capable of running a variety of processes defined by various pieces of code, which are illustrated in FIG. 2. FIG. 2 is a block diagram showing a processor 200 in communication with processes defined by various pieces of code 205, 210, 215, 220. The operating system (“OS”) code 205 defines the high level processes that direct all activities performed by the information storage and retrieval system. Host Adapter Interface (“HAI”) code 210 defines processes that govern communication between the information storage and retrieval system and the host computer via the host adapter cards. Cache code 215 defines processes that manage the cache and NVS code 220 defines the processes that manage the NVS.

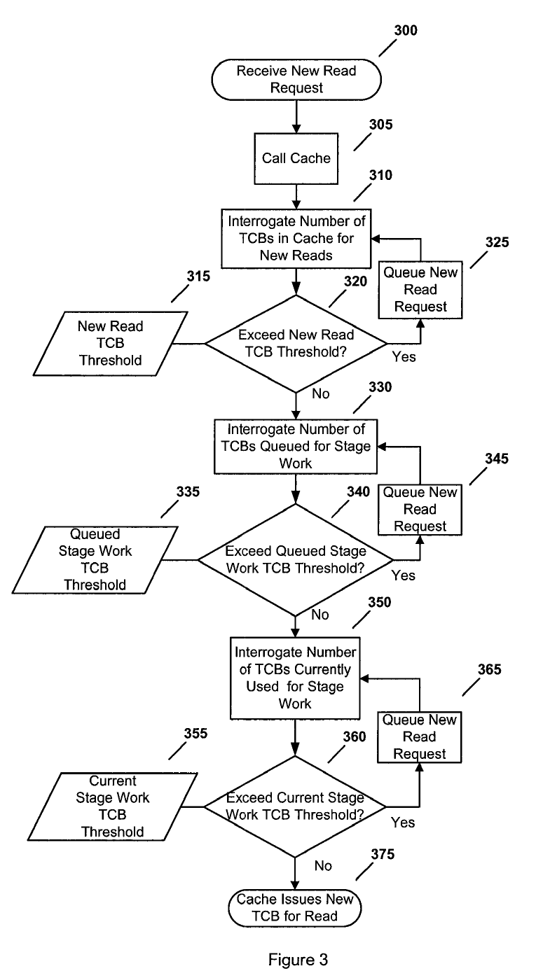

FIG. 3 illustrates the steps taken by a data storage and retrieval system allocating TCBs during a read operation performed according to one embodiment of the invention. A new read request (step 300) is received by HAI code. The system then calls the cache code (step 305) to manage allocation of the TCB which is to be associated with the new read request. The cache code interrogates the number of TCBs currently being held in the cache for previous new read requests (step 310). The number of TCBs currently being held in the cache for previous new read requests is compared to a new read TCB threshold (step 315), which represents a maximum number of TCBs that can be issued at any time for new read requests. The new read TCB threshold (step 315) can be a user set parameter, or can be dynamically set according to system performance. The system determines whether the current number of TCBs in the cache for new read requests exceeds the new read TCB threshold (step 320). If the new read TCB threshold is exceeded, the system queues the new read request (step 325) until the number of TCBs already allocated for new reads drops below the threshold.

If the current number of TCBs allocated for new reads is below the threshold, the system then interrogates the Device Adapter to determine the number of TCBs currently queued to perform staging of data from the disk drives (step 330). The system compares the number of TCBs queued for stage work with a queued stage work TCB threshold (step 335). The queued stage work TCB threshold (step 335) can be a user set parameter, or can be dynamically set according to system performance. The system determines whether the number of TCBs queued for stage work exceeds the queued stage work TCB threshold (step 340). If the queued stage work TCB threshold is exceeded, the system queues the new read request (step 345) until the number of TCBs already queued for stage work drops below the queued stage work TCB threshold.

If the current number of TCBs currently queued for stage work is below the queued stage work TCB threshold, the system then interrogates the Device Adapter to determine the number of TCBs currently being used to perform staging of data from the disk drives (step 350). The system compares the number of TCBs currently being used for stage work with a current stage work TCB threshold (step 355). The current stage work TCB threshold (step 355) can be a user set parameter, or can be dynamically set according to system performance. The system determines whether the number of TCBs currently being used for stage work exceeds the current stage work TCB threshold (step 360). If the current stage work TCB threshold is exceeded, the system queues the new read request (step 365) until the number of TCBs already being used for stage work drops below the current stage work TCB threshold. If the current stage work TCB threshold is not exceeded, the cache code issues a new TCB and the read is allowed to proceed (step 375).

The embodiment of FIG. 3 is described as a three-step, sequential decision making process whereby the cache code looks to see how many TCBs have been allocated for new reads, how many TCBs have been queued for stage work, and how many TCBs are currently being used for stage work before issuing a TCB for the new read. The embodiment of FIG. 3 is meant to be exemplary only. The individual steps described in reference to FIG. 3 can optionally be omitted, combined, or reordered. Any method that allocates TCBs for new reads on the basis of the number and distribution of TCBs allocated for other tasks in an information storage and retrieval system is within the contemplated scope of the invention.

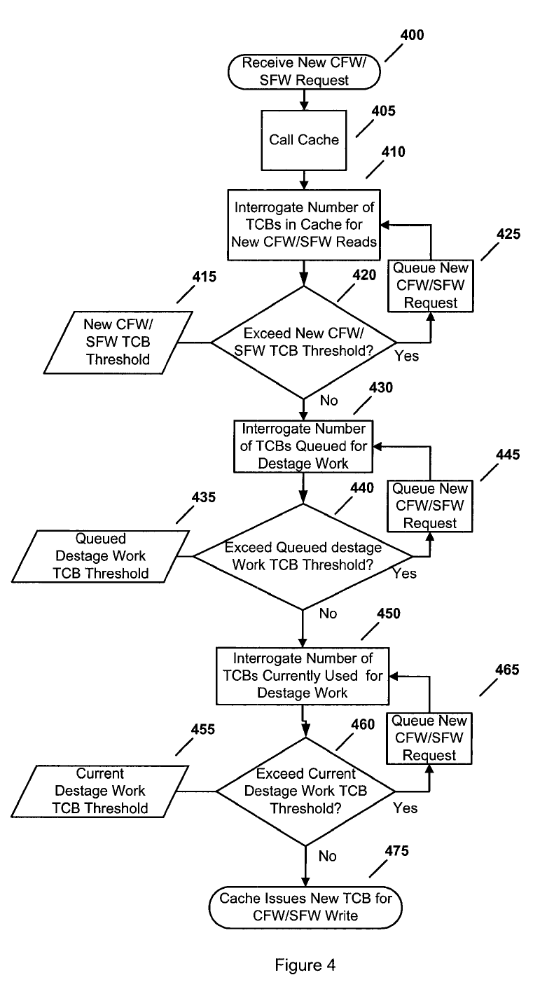

FIG. 4 illustrates the steps taken by a data storage and retrieval system allocating TCBs during a Cache Fast Write (“CFW”) or Sequential Fast Write (“SFW”) operation performed according to one embodiment of the invention. A new CFW/SFW request (step 400) is received by HAI code. The system then calls the cache code (step 405) to manage allocation of the TCB which is to be associated with the new write request. The cache code interrogates the number of TCBs currently being held in the cache for previously requested new CFW/SFW requests (step 410). The number of TCBs currently being held in the cache for previous new CFW/SFW requests is compared to a new CFW/SFW TCB threshold (step 415), which represents a maximum number of TCBs that can be issued at any time for new CFW/SFW requests. The new CFW/SFW TCB threshold (step 415) can be a user set parameter, or can be dynamically set according to system performance. The system determines whether the current number of TCBs in the cache for new CFW/SFW requests exceeds the new CFW/SFW TCB threshold (step 420). If the new CFW/SFW TCB threshold is exceeded, the system queues the new write request (step 425) until the number of TCBs already allocated for new CFW/SFW drops below the threshold.

If the current number of TCBs allocated for new CFW/SFW requests is below the new CFW/SFW TCB threshold, the system then interrogates the Device Adapter to determine the number of TCBs currently queued to perform destaging of data to the disk drives (step 430). The system compares the number of TCBs queued for destage work with a queued destage work TCB threshold (step 435). The queued destage work TCB threshold (step 435) can be a user set parameter, or can be dynamically set according to system performance. The system determines whether the number of TCBs queued for destage work exceeds the queued destage work TCB threshold (step 440). If the queued destage work TCB threshold is exceeded, the system queues the new CFW/SFW request (step 445) until the number of TCBs already queued for destage work drops below the queued destage work TCB threshold.

If the current number of TCBs currently queued for destage work is below the queued destage work TCB threshold, the system then interrogates the Device Adapter to determine the number of TCBs currently being used to perform destaging of data from the disk drives (step 450). The system compares the number of TCBs currently being used for destage work with a current destage work TCB threshold (step 455). The current destage work TCB threshold (step 455) can be a user set parameter, or can be dynamically set according to system performance. The system determines whether the number of TCBs currently being used for destage work exceeds the current destage work TCB threshold (step 460). If the current destage work TCB threshold is exceeded, the system queues the new CFW/SFW request (step 465) until the number of TCBs already being used for destage work drops below the current destage work TCB threshold. If the current destage work TCB threshold is not exceeded, the cache code issues a new TCB and the CFW/SFW is allowed to proceed (step 475).

The embodiment of FIG. 4 is described as a three-step, sequential decision making process whereby the cache code looks to see how many TCBs have been allocated for new CFW/SFW requests, how many TCBs have been queued for destage work, and how many TCBs are currently being used for destage work before issuing a TCB for the new CFW or SFW. The embodiment of FIG. 4 is meant to be exemplary only. The individual steps described in reference to FIG. 4 can optionally be omitted, combined, or reordered. Any method that allocates TCBs for new CFW or SFW requests on the basis of the number and distribution of TCBs allocated for other tasks in an information storage and retrieval system is within the contemplated scope of the invention.

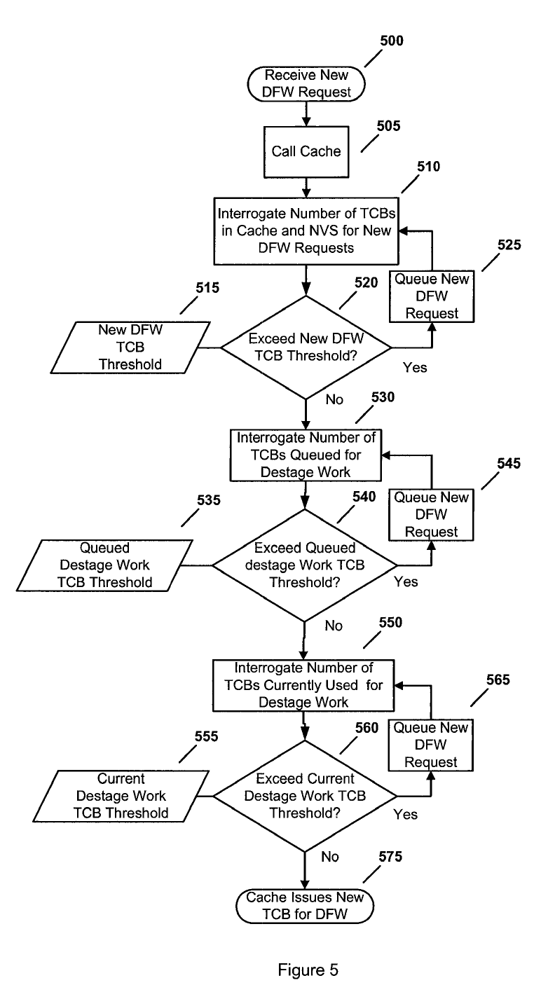

FIG. 5 illustrates the steps taken by a data storage and retrieval system allocating TCBs during a Data Storage Device Fast Write (“DFW”) operation performed according to one embodiment of the invention. A new DFW request (step 500) is received by HAI code. The system then calls the cache code (step 505) to manage allocation of the TCB which is to be associated with the new DFW write request. The cache code interrogates the number of TCBs currently being held in the cache and in the NVS for previously requested new DFW requests (step 510). The number of TCBs currently being held in the cache for previous new DFW requests is compared to a new DFW threshold (step 515), which represents a maximum number of TCBs that can be issued at any time for new DFW requests. The new DFW TCB threshold (step 515) can be a user set parameter, or can be dynamically set according to system performance. The system determines whether the current number of TCBs in the cache and NVS for new DFW requests exceeds the new DFW TCB threshold (step 520). If the new DFW TCB threshold is exceeded, the system queues the new write request (step 525) until the number of TCBs already allocated for new DFW drops below the threshold.

If the current number of TCBs allocated for new DFW requests is below the new DFW TCB threshold, the system then interrogates the Device Adapter to determine the number of TCBs currently queued to perform destaging of data to the disk drives (step 530). The system compares the number of TCBs queued for destage work with a queued destage work TCB threshold (step 535). The queued destage work TCB threshold (step 535) can be a user set parameter, or can be dynamically set according to system performance. The system determines whether the number of TCBs queued for destage work exceeds the queued destage work TCB threshold (step 540). If the queued destage work TCB threshold is exceeded, the system queues the new DFW request (step 545) until the number of TCBs already queued for destage work drops below the queued destage work TCB threshold.

If the current number of TCBs currently queued for destage work is below the queued destage work TCB threshold, the system then interrogates the Device Adapter to determine the number of TCBs currently being used to perform destaging of data to the disk drives (step 550). The system compares the number of TCBs currently being used for destage work with a current destage work TCB threshold (step 555). The current destage work TCB threshold (step 555) can be a user set parameter, or can be dynamically set according to system performance. The system determines whether the number of TCBs currently being used for destage work exceeds the current destage work TCB threshold (step 560). If the current destage work TCB threshold is exceeded, the system queues the new request (step 565) until the number of TCBs already being used for destage work drops below the current destage work TCB threshold. If the current destage work TCB threshold is not exceeded, the cache code issues a new TCB and the DFW is allowed to proceed (step 575).

The embodiment of FIG. 5 is described as a three-step, sequential decision making process whereby the cache code looks to see how many TCBs have been allocated for new DFW requests (i.e., how many new DFW requests are waiting in cache and NVS), how many TCBs have been queued for destage work, and how many TCBs are currently being used for destage work before issuing a TCB for the new DFW. The embodiment of FIG. 5 is meant to be exemplary only. The individual steps described in reference to FIG. 5 can optionally be omitted, combined, or reordered. The step of looking at cache and NVS to determine the number of already issued DFW TCBs can be optionally divided into two separate steps. Any method that allocates TCBs for new DFW requests on the basis of the number and distribution of TCBs allocated for other tasks in an information storage and retrieval system is within the contemplated scope of the invention.

In addition to the methods set forth above, the invention includes an article of manufacture comprising a computer useable medium having computer readable program code disposed therein to efficiently allocate TCBs in a storage and retrieval system. The invention further includes a computer program product usable with a programmable computer processor having computer readable program code embodied therein to efficiently allocate TCBs in a data storage and retrieval system.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method of allocating Task Control Blocks in an information storage and retrieval system communicating with one or more host computers, wherein said information storage and retrieval system comprises a host adapter interface, a cache code for issuing Task Control Blocks, a data cache, a non-volatile storage, a new read Task Control Block threshold, a device adapter, and one or more information storage devices, said device adapter interconnecting said data cache and said one or more information storage devices, said method comprising the steps of:
receiving a new read request from the host adapter interface;
calling the cache code;
determining a number of Task Control Blocks already issued for previous new reads;
comparing the number of Task Control Blocks already issued for previous new reads with the new read Task Control Block threshold; and
if the number of Task Control Blocks already issued for previous new reads exceeds the new read Task Control Block threshold, queuing the new read request;
alternatively, if the number of Task Control Blocks already issued for previous new reads does not exceed the new read Task Control Block threshold, issuing a Task Control Block corresponding to the new read request from the cache code.

2. The method of claim 1 in an information data storage and retrieval system further comprising a queued stage work TCB threshold, the method further comprising the steps of:
determining a number of Task Control Blocks queued to perform staging of data from the one or more information storage devices to the cache;
comparing the number of Task Control Blocks queued to perform staging of data from the one or more information storage devices to the cache with the queued stage work TCB threshold; and
if the number of Task Control Blocks queued to perform staging of data from the one or more information storage devices to the cache exceeds the queued stage work TCB threshold, queuing the new read request;
alternatively, if the number of Task Control Blocks queued to perform staging of data from the one or more information storage devices to the cache does not exceed the queued stage work TCB threshold, issuing a Task Control Block corresponding to the new read request from the cache code.

3. The method of claim 2 in an information data storage and retrieval system further comprising a current stage work TCB threshold, the method further comprising the steps of:
determining a number of Task Control Blocks currently perform staging of data from the one or more information storage devices to the cache;
comparing the number of Task Control Blocks currently performing staging of data from the one or more information storage devices to the cache with the current stage work TCB threshold; and
if the number of Task Control Blocks currently performing staging of data from the one or more information storage devices to the cache exceeds the current stage work TCB threshold, queuing the new read request;
alternatively, if the number of Task Control Blocks currently performing staging of data from the one or more information storage devices to the cache does not exceed the current stage work TCB threshold, issuing a Task Control Block corresponding to the new read request from the cache code.

4. A method of allocating Task Control Blocks in an information storage and retrieval system communicating with one or more host computers, wherein said information storage and retrieval system comprises a host adapter interface, a cache code for issuing Task Control Blocks, a data cache, a non-volatile storage, a new write TCB threshold, a device adapter, and one or more information storage devices, said device adapter interconnecting said data cache and said one or more information storage devices, said method comprising the steps of:
receiving a new write request from the host adapter interface;
calling the cache code;
determining a number of Task Control Blocks already issued for previous new writes;
comparing the number of Task Control Blocks already issued for previous new writes with the new write Task Control Block threshold; and
if the number of Task Control Blocks already issued for previous new writes exceeds the new write Task Control Block threshold, queuing the new write request;
alternatively, if the number of Task Control Blocks already issued for previous new writes does not exceed the new write Task Control Block threshold, issuing a Task Control Block corresponding to the new write request from the cache code.

5. The method of claim 4 in an information data storage and retrieval system further comprising a queued destage work TCB threshold, the method further comprising the steps of:
determining a number of Task Control Blocks queued to perform destaging of data from the cache to the one or more information storage devices;
comparing the number of Task Control Blocks queued to perform destaging of data from cache to the one or more information storage devices with the queued destage work TCB threshold; and
if the number of Task Control Blocks queued to perform destaging of data from the cache to the one or more information storage devices exceeds the queued destage work TCB threshold, queuing the new write request;
alternatively, if the number of Task Control Blocks queued to perform destaging of data from the cache to the one or more information storage devices does not exceed the queued destage work TCB threshold, issuing a Task Control Block corresponding to the new write request from the cache code.

6. The method of claim 5 in an information data storage and retrieval system further comprising a current destage work TCB threshold, the method further comprising the steps of:
determining a number of Task Control Blocks currently performing destaging of data from the cache to the one or more information storage devices;
comparing the number of Task Control Blocks currently performing destaging of data from cache to the one or more information storage devices with the current destage work TCB threshold; and
if the number of Task Control Blocks currently performing destaging of data from the cache to the one or more information storage devices exceeds the current destage work TCB threshold, queuing the new write request;
alternatively, if the number of Task Control Blocks currently performing destaging of data from the cache to the one or more information storage devices does not exceed the current destage work TCB threshold, issuing a Task Control Block corresponding to the new write request from the cache code.

7. The method of claim 4 wherein the new write request is a new request for a cache fast write.

8. The method of claim 4 wherein the new write request is a new request for a sequential fast write.

9. The method of claim 4 wherein the new write request is a new request for a data storage device fast write.

10. The method of claim 9 wherein the step of determining a number of Task Control Blocks already issued for previous new writes includes determining the number of Task Control Blocks already issued for previous new writes in cache and non-volatile storage.

11. An information storage and retrieval system communicating with one or more host computers, the system comprising a host adapter interface, a cache code for issuing Task Control Blocks, a data cache, a non-volatile storage, a new write TCB threshold, a device adapter, and one or more information storage devices, said device adapter interconnecting said data cache and said one or more information storage devices, the system operable to:
receive a new write request from the host adapter interface;
call the cache code;
determine a number of Task Control Blocks already issued for previous new writes;
compare the number of Task Control Blocks already issued for previous new writes with the new write Task Control Block threshold; and
if the number of Task Control Blocks already issued for previous new writes exceeds the new write Task Control Block threshold, queue the new write request;
alternatively, if the number of Task Control Blocks already issued for previous new writes does not exceed the new write Task Control Block threshold, issue a Task Control Block corresponding to the new write request from the cache code.

12. The system of claim 11, the system further comprising a queued destage work TCB threshold, the system further operable to:
determine a number of Task Control Blocks queued to perform destaging of data from the cache to the one or more information storage devices;
compare the number of Task Control Blocks queued to perform destaging of data from cache to the one or more information storage devices with the queued destage work TCB threshold; and
if the number of Task Control Blocks queued to perform destaging of data from the cache to the one or more information storage devices exceeds the queued destage work TCB threshold, queue the new write request;
alternatively, if the number of Task Control Blocks queued to perform destaging of data from the cache to the one or more information storage devices does not exceed the queued destage work TCB threshold, issue a Task Control Block corresponding to the new write request from the cache code.

13. The system of claim 12, the system further comprising a current destage work TCB threshold, the system further operable to:
determine a number of Task Control Blocks currently performing destaging of data from the cache to the one or more information storage devices;
compare the number of Task Control Blocks currently performing destaging of data from cache to the one or more information storage devices with the current destage work TCB threshold; and
if the number of Task Control Blocks currently performing destaging of data from the cache to the one or more information storage devices exceeds the current destage work TCB threshold, queue the new write request;
alternatively, if the number of Task Control Blocks currently performing destaging of data from the cache to the one or more information storage devices does not exceed the current destage work TCB threshold, issue a Task Control Block corresponding to the new write request from the cache code.

14. The system of claim 11 wherein the new write request is a new request for a cache fast write.

15. The system of claim 11 wherein the new write request is a new request for a sequential fast write.

16. The system of claim 11 wherein the new write request is a new request for a data storage device fast write.

17. The system of claim 16 wherein the system is further operable to determine the number of Task Control Blocks already issued for previous new writes by determining the number of Task Control Blocks already issued for previous new writes in cache and non-volatile storage.
